(19) United States
(12) Patent Application Publication
(10) Pub. No.: US 2016/0075164 A1
(43) Pub. Date: Mar. 17, 2016

(54) SECURITY ELEMENT COMPRISING A VOLUME HOLOGRAM

(71) Applicant: ARJOWIGGINS SECURITY, Boulogne Billancourt (FR)

(72) Inventor: Pierre SARRAZIN, Saint Geoire En Valdaine (FR)

(73) Assignee: Arjowiggins Security, Boulogne Billancourt (FR)

(21) Appl. No.: 14/786,791

(22) PCT Filed: Apr. 10, 2014
(86) PCT No.: PCT/IB2014/060629

§ 371 Date: Oct. 23, 2015

(30) Foreign Application Priority Data
Apr. 26, 2013 (FR) 13 53843

(51) Int. Cl. B42D 25/328

(52) U.S. Cl. CPC B42D 25/328

(57) ABSTRACT

The present invention relates to a security element (20) to be built into an item, particularly a document (10), said security element comprising a holographic layer, enabling a volume hologram to be generated, and a non-holographic variable opacity structure generated by the presence of: a) one or more cutout(s) and/or at least partially translucent areas and moreover at least partially opaque area(s); and/or b) oriented platelet pigments. The variable opacity structure is at least partially placed over the hologram within a region of the security element observable in transmitted light.

The present invention relates to security elements and secured items, particularly documents, comprising such elements.

### BACKGROUND

Holograms are widely used for securing documents.

U.S. Pat. No. 6,873,444 B1 discloses a method of producing a volume hologram, also called a LIPPMANN BRAGG hologram or LIPPMANN hologram.

EP 2453320 A1 describes a method of producing a volume hologram, in which the holographic layer is protected on the surface by a protective film. The holographic layer is attached by an adhesive layer.

U.S. Pat. No. 4,171,766 discloses the use of a hologram carried by a sheet attached onto an identity card.

EP 0403134 A2 teaches superimposing a hologram and information present on packaging.

EP 1511636 B1 discloses the superimposition of a surface hologram and a volume hologram.

EP 2362275 A1 discloses a volume hologram arranged in front of a window of a banknote.

EP 2530533 A1 describes a security element comprising a holographic layer in which a volume hologram is recorded, attached onto a substrate using an adhesive. A colored layer may cover the holographic layer. The colored layer may be deposited by printing. In one example, a non-opaque layer of blue ink 0.5 μm thick after drying is deposited.

US 2012/0257266 A1 teaches attaching two holographic layers together each reproducing a volume hologram.

US 2013/0003153 Al describes the addition of a luminescent compound within a holographic layer.

US 2011/0049864 Al describes a volume hologram covering information on a substrate, printed in relief. A layer of adhesive covers this printing and has a variable thickness because of the relief of the printing, which entails a differentiated diffusion of the adhesive in the material in which the hologram is recorded and a local change in the color of the hologram. The diffusion of the adhesive is complex to control.

WO 2012/007120 describes a security element comprising a volume hologram superimposed on a surface hologram in which cutouts are made. The security element is complex to visualize, because of the presence of a diffractive hologram and a volume hologram. In addition, the security element is complex and expensive to produce. The volume hologram is recorded with a pattern, so that the step of recording the hologram is complex and costly. The visual effects dependent on the angle of observation are obtained thanks to the surface hologram.

WO 2011/107527 discloses a security thread comprising a coating, within which oriented pigments are present. This thread may optionally include a holographic layer.

WO 03/009581 describes a security element comprising both surface and volume holographic structures.

### SUMMARY

There is a need for further improving security elements and the secured items, particularly documents, incorporating such elements.

The subject matter of the invention, according to a first of its aspects, relating to the presence of a variable opacity structure, is a security element to be incorporated into an item, particularly a document, comprising:
a holographic layer for generating a volume hologram,
a non-holographic variable opacity structure generated by the presence of

a) one or more cutouts and/or at least partially translucent areas as well as one or more at least partially opaque areas, and/or

b) oriented platelet pigments,

the variable opacity structure being at least partially superimposed on the hologram in a region of the security element observable in transmitted light.

The presence of the volume hologram makes it possible to obtain a visual effect which depends on the angle of observation. During observation, the volume hologram is preferably located behind the variable opacity structure with respect to the observer. Preferably again, the volume hologram is a hologram visible in reflection.

The hologram is at least partially superimposed on the one hand on at least one cutout and/or on one at least partially translucent area and on the other hand on one at least partially opaque area and/or is at least partially superimposed on said platelet pigments. Thanks to the invention, the hologram may be used for helping to visually perceive the variable opacity structure and/or to modify the appearance thereof.

The invention makes it possible to create a first level of security, easily identifiable by the man in the street, and benefits from new aesthetic and attractive effects with relatively low production costs.

The volume hologram, by its nature, offers sufficient transparency for enabling the variable opacity structure to be observed in transmitted light.

The presence of the hologram brings a color and/or animation effect to the observation of the variable opacity structure, which may thus make it stand out further for the man in the street.

‘Variable opacity’ must be understood to mean that the opacity varies in the plane of the structure and/or according to the angle of observation.

‘At least partially opaque’ must be understood to mean an opacity in daylight corresponding to an optical density of at least 0.7, corresponding to approximately 20% transmission, better at least 1, even better 1.5. The variable opacity structure may comprise areas completely opaque to the eye, for observing in front of an illuminated background such as a white sheet.

‘At least partially translucent’ must be understood to mean a translucence in daylight corresponding to an optical density strictly less than 0.7, corresponding to approximately 20% transmission, better an optical density less than 0.5.

Between the properties ‘at least partially opaque’ and ‘at least partially translucent’, it is preferable to have a difference in optical density at least greater than 0.5, more preferably at least 0.7.

The variation in opacity may be linked to the presence of metalization/demetalization and/or printing. In this case, the cutout or cutouts may be formed by absences of metalization or ink. The opaque layer may be other than a fibrous substrate, and the non-opaque area other than a simple window arranged in this substrate.

In the case of metalization, the thickness of metal of the variable opacity structure is preferably sufficient for conferring an optical density of at least 1.5. The optical density is, for example, measured using a TOBIAS ASSOCIATES, INC, TBX-MC densitometer, the measurement being performed according to ISO standard 5/2. The metalization is preferably performed under vacuum, as it provides more security, since its implementation then requires more complex industrial means.

In the case of printing, the ink used is preferably a pigmented ink, preferably of non-achromatic color (i.e. non-black and non-white) and also preferably having a D50 particle size of pigments greater than 5 μm, in order to achieve a reduced transparency. The ink may comprise particles of a metal as pigment.

In the case of printing also, the ink may comprise platelet pigments capable of being oriented under the effect of a magnetic field, which is used to create a layer the opacity of which varies according to the angle of observation, passing through a maximum in a direction parallel to the direction of orientation of the platelets and through a minimum when the direction of observation is substantially perpendicular to the plane of the platelets. Such pigments are known through the publication EP1819525 B1.

In the case of reflective platelet pigments, these are either transparent in the case of observation in the direction of inclination of the platelets, or opaque in the case of an observation perpendicular to the platelets.

The variation in opacity may be associated with a pattern, which may be reproduced elsewhere on the document provided with the security element. For example, a cutout or an area at least partially translucent defines a pattern present elsewhere on the document or the security element. This pattern may be a number or a letter.

The variation in opacity may be obtained by a text in negative, e.g. of the CLEARTEXT® type, the recesses defining the text corresponding to the areas of the variable opacity structure which are non-opaque, since, for example, they are not printed or demetalized.

The security element may comprise a variable chromaticity layer.

‘Variable chromaticity’ must be understood to mean that the observed color varies in the plane of the element and/or according to the angle of observation.

For example, a variable chromaticity layer is obtained by juxtaposing non-opaque areas of different colors in a plane. These areas may have the same opacity overall. This variable chromaticity layer may be at least partially superimposed on the holographic layer and the variable opacity structure. The presence of such a layer may be used to create new optical effects.

The variable chromaticity layer may further be achieved with a goniochromatic pigment, e.g. an iridescent or liquid crystal pigment, or via a diffraction network, a surface hologram or a photonic structure.

The element may comprise a backing layer, particularly a film made of PET, or a layer made of fibrous material.

According to another of its aspects relating to the presence of a semi-reflective layer, independently or in combination with the foregoing or the following, the subject matter of the invention is also a security element for a secured item, particularly a document, comprising:
a holographic layer for generating a volume hologram,
a semi-reflective layer, at least partially superimposed on the holographic layer and preferably also on a variable opacity structure, the holographic layer being located preferably between the semi-reflective layer and the variable opacity structure. Advantageously, the semi-reflective layer is used to enhance the volume hologram owing to the reflective appearance of the layer while maintaining visibility in transmitted light. In addition, this semi-reflective layer may serve to mask the security element when the latter is introduced into a ‘windows thread’, which is particularly useful when a colored layer is superimposed on the security element. Finally in the case of a security element arranged in a through-window, the semi-reflective layer masks the security element in reflection on the face on which the layer is arranged.

According to another of its aspects relating to the presence of a diffusing structure, independently or in combination with the foregoing or the following, the subject matter of the invention is also a security element for a secured item, particularly a document, comprising:
a holographic layer for generating a volume hologram,
a diffusing structure, at least partially superimposed on the holographic, particularly micro-embossed layer, the holographic layer being preferably located between the diffusing structure and a variable opacity structure at least partially superimposed on the holographic layer and the diffusing structure.

Such a security element offers advantages which are detailed farther on.

According to another of its aspects relating to the presence of a luminescent agent, independently or in combination with the foregoing or the following, the subject matter of the invention is also a security element for a secured item, particularly a document, comprising:
a holographic layer for generating a volume hologram,
a layer containing a luminescent agent at least partially superimposed on the holographic layer, better a first and a second luminescent layer each at least partially superimposed on the holographic layer and preferably at least partially superimposed therebetween, the luminescent layers preferably having colors of different luminescence.

Such a security element can be used to obtain new optical effects under lighting causing the luminescence.

According to another of its aspects relating to the presence of two holographic layers, independently or in combination with the foregoing or the following, the subject matter of the invention is also a security element for a secured item, particularly a document, comprising:
a first holographic layer for generating a first volume hologram, recorded in transmission,
a second holographic layer for generating a second volume hologram, recorded in reflection, at least partially superimposed on the first.

Such a security element may comprise a first variable opacity structure at least partially superimposed on the two volume holograms and preferably a second variable opacity structure also superimposed on the two volume holograms, the variable opacity structure or structures being positioned externally to the holographic layers; in the case of a structure comprising two holographic layers, the variable opacity structures may thus be located respectively on opposite sides of the security element.

Advantageously, the security element is then produced in two portions arranged respectively on each side of a fibrous substrate traversed by a window. Each portion comprises one of the holographic layers and the associated variable opacity structure.

Such a security element brings new optical effects and additional security.

According to another of its aspects, relating to the presence of a variable chromaticity layer, independently or in combination with the foregoing or the following, the subject matter of the invention is also a security element for a secured item, particularly a document, comprising:
a holographic layer for generating a volume hologram,
a variable chromaticity layer comprising multiple colored areas of different colors, superimposed on the holographic layer, at least one of these colored areas, and preferably all of these colored areas, being transparent,
and preferably, a variable opacity structure at least partially superimposed on the holographic layer and on said colored areas.

The holographic layer may be recorded so as to reproduce at least two holograms consisting of different solid colors, to be combined in various ways with the colored areas of the variable chromaticity layer.

Volume hologram

For all aspects of the invention, ‘volume hologram’ must be understood as meaning a hologram generated by reflection or transmission of light by forming a network of interference fringe planes or interference network (Bragg network) recorded in the thickness of a sensitive, preferably photosensitive layer.

The holographic layer may present a smooth exterior structure, unlike surface holograms created by embossing.

One example of embodiment of a volume hologram is given in patent U.S. Pat. No. 5,319,476, column 2, lines 18 to 44 and in application U.S. 2013/0003153 A1, [0017] to [0022].

The holographic layer may consist of a complex produced with a layer 6 to 15 μm thick, better between 8 and 10 μm, of a photosensitive resin deposited on a carrier film, preferably made of PET, 6 or 12 μm thick, which may also serve as a protective layer if necessary.

The holographic layer may also consist of a holographic complex comprising a layer of a photosensitive resin and a film carrier, as well as a layer of an adhesive between the two, as described in application EP 2530533 A1. The photosensitive resin layer is, for example, as described in paragraphs [0041] to [0050] or [0051] to [0058].

The hologram may be reproduced in non-coherent white light.

The hologram may reproduce just a solid color, i.e. patternless, e.g. red, green, blue, yellow, cyan, magenta, or an animation, e.g. changing from one solid color to another color, when the angle of observation changes. For example, the hologram reproducing a patternless solid color may be obtained by reflection or transmission of light from a flat object, having a substantially uniform surface, by forming a network of interference fringe planes or interference network, which is recorded in the thickness of a photosensitive layer. Creating the hologram in such a way that it reproduces only a solid color makes it relatively inexpensive to produce.

When the variable opacity structure comprises oriented platelet pigments, it may be particularly advantageous that the direction of observation of the hologram that reveals the recorded image, coincides with the direction of orientation of the platelet pigments. A security is obtained that is particularly difficult to counterfeit.

In the case of a volume hologram recorded in reflection, the observer may perceive, when looking at the security element in transmitted light behind an incoherent white light source, the variable opacity structure without perceiving the hologram. When the observer observes the security element in reflection, they can see the variable opacity structure illuminated by the hologram, at least for one observation direction.

In the case of a volume hologram recorded in transmission, the observer may perceive by observation in reflection only the variable opacity structure. The color generated by the hologram appears when the hologram is observed in transmitted light, in which case the variable opacity structure is visible with the hologram.

The hologram may only consist of a single recorded pattern, which may be a solid color. As a variant, the hologram may comprise multiple recorded patterns, which may each be a solid color. In this case, multiple patterns may be arranged to appear respectively behind different patterns of the variable opacity structure; for example, the latter comprises a text in negative writing and different letters of this text appear in different colors owing to the presence of solid colors different from the volume hologram.

The volume hologram may also comprise different patterns, e.g. different solid colors, which are arranged so as to appear in the same window of the document.

The volume hologram may further be created so as to have patterns that are recorded so as to appear for different respective observation angles. This may, for example, involve multiple solid colors that become visible for different respective observation angles. These solid areas may be superimposed on different patterns of the variable opacity structure, e.g. different letters in negative writing. In this case, when the security element is progressively tilted with respect to the observer so as to reveal the patterns, they may become successively visible, according to the increase in the observation angle.

The holographic layer may be recorded with a solid color and be superimposed on a colored layer with interposition of the variable opacity layer, so that this holographic layer appears with at least two areas of different colors, owing to the fact of their superimposition with the colored layer and the presence of the variable opacity layer. The areas that appear of different colors may be juxtaposed in the plane of the holographic layer.

The holographic layer may be recorded with areas whereof the color appears for different observation angles.

As a variant, both the colors and the angles for which these colors appear are distinct.

Security element

For all aspects of the invention, the security element may be in the form of an element which is incorporated in a fibrous substrate during its manufacture or which is added to its surface. The security element takes the form, for example, of a patch, security thread or foil or protective film with variable data.

The security element may be exposed to the outside environment on its two opposing faces or be so on only one of them or be covered on both its faces by one or more non-opaque layers. The security element may be in a single piece at the time of its incorporation in the item, particularly the document, or be composed of several sub-elements which are assembled via the item, particularly the document, e.g. being added onto different faces of the substrate.

These sub-elements may or may not be in contact with one another. One may carry the hologram and the other the variable opacity structure. One may be attached onto one face of the substrate, and the other onto the opposite face, on each side of a document window.

The thickness of the security element may be less than or equal to 50 μm, being, for example, between 30 and 40 μm.

The security element may comprise a semi-reflective layer that is at least partially superimposed on the holographic layer and the variable opacity structure. This may be a metal layer of sufficiently fine thickness to be semi-reflective, or a printed or metalized raster.

The security element may comprise a diffusing structure that is at least partially superimposed on the holographic layer and the variable opacity structure.

It may be a micro-embossed layer, particularly a layer of a micro-embossed adhesive.

In one example of implementation of the invention, the element comprises a non-opaque colored layer at least partially superimposed on the hologram and/or on the variable opacity structure, particularly a colored layer presenting a uniform color or multiple solid colors, particularly in the form of juxtaposed areas. The colored layer may be colored by printing and/or in the mass, particularly by adding dye(s) or colored pigment(s).

In one example of implementation of the invention, the element comprises a second holographic layer for generating a second volume hologram, at least partially superimposed on the first hologram, the second hologram being superimposed on at least one non-opaque area of the variable opacity structure, one of the two holograms, preferably the one closest to the observer, being preferably a hologram recorded in transmission and the other a hologram recorded in reflection, the two holograms being preferably located on each side of a substrate comprising a window through which an observation may be made in transmitted light.

In one example of implementation of the invention, the security element comprises different first and second holograms, particularly having different colors and/or patterns, particularly recorded in said holographic layer or in respective first and second holographic layers, the first and second hologram being respectively superimposed preferably on different patterns defined by the variable opacity structure, e.g. different alphanumeric characters of a text in negative writing, or being intended to appear in different windows of a substrate.

In one example of implementation of the invention, the hologram comprises two juxtaposed areas of different colors, and the security element comprises two juxtaposed colored areas, of different colors, superimposed on the colored areas of the hologram, particularly with superimposition of a colored area of the hologram with a respective colored area.

Secured Item, Particularly a Document

The subject matter of the invention is also a secured item, particularly a document, comprising a security element according to the invention, according to any one of its aspects, observable in transmitted light at least in said region of superimposition of the volume hologram and of the variable opacity structure, of the semi-reflective layer of the diffusing structure, of the variable chromaticity layer and/or of another holographic layer generating a volume hologram.

The security element may be superimposed on a document window, particularly a through-window.

The window may be a through-window and the security element be arranged on one side of the window, with a sealing film being arranged on the other side of the window.

Alternatively, the variable opacity structure may be arranged on one side of the document and the volume hologram arranged on the opposite side, with the structure and the hologram being at least partially superimposed on the through-window.

The sealing film may be colored, particularly colored in the mass or by printing, or metalized with an optical density of less than 2, preferably less than 1.

Preferably, whether the security element is arranged on one side of the window, or the variable opacity structure is arranged on one side of the document and the volume hologram arranged on the other side, the security element may further be provided with a semi-reflective layer on the side of the hologram opposite that of the variable opacity structure. The semi-reflective nature makes it possible to observe the pattern of the variable opacity structure in transmitted light, since it is non-opaque.

The item may be a passport, an identity card, an access card, a driving license, a playing or interactive collecting card, a means of payment, particularly a payment card, a banknote, a tax stamp, a license tag, a voucher or a coupon, a travel, loyalty, benefit, or subscription card, a token or a casino chip.

Method of Authentication

The subject matter of the invention is also a method of authenticating an item, particularly a document, secured according to the invention, comprising the observation of the security element in transmission and/or in reflection. In transmission, the pattern is observed formed, for example, by demetalization, and in reflection this pattern appears through the volume hologram arranged below, when the hologram has been recorded in reflection. It is not necessary to place the security element in front of a dark background.

Observation may take place in visible light, particularly white, e.g. by looking at the light source through the security element. This observation can be used, for example, to recognize information conveyed by the variable opacity structure, e.g. a text or a pattern.

In this case, the hologram is not visible when it has been recorded in reflection.

The security element in reflection may also be observed, particularly when the latter presents a directly observable outer face. This observation in reflection makes it possible to see at least one color generated by the hologram, in the case where the latter is recorded in reflection.

In the case of a hologram recorded in transmission, the latter appears in transmitted light.

The security element may comprise both a hologram recorded in reflection and a hologram recorded in transmission, the holographic layers generating these holograms being superimposed.

In this case, the authentication method advantageously comprises an observation in transmission and an observation in reflection.

In general, observation may further take place in UV or IR light, when the hologram reproduces light in the visible domain under UV or IR illumination. In this case, the security element advantageously comprises a luminescent, e.g. fluorescent, agent, which also appears during observation, and the color effects of which may be combined with those of the hologram.

In one example of implementation of the invention, the inclination of the angle of observation is varied with respect to the security element and information is sorted concerning authenticity in the event of the successive appearance of patterns, particularly formed by demetalization, along the security element. Observation may be performed with the hologram located behind the variable opacity structure with respect to the observer.

The invention may be better understood on reading the following detailed description of non-restrictive examples of implementation thereof, and on examining the accompanying drawing, in which:

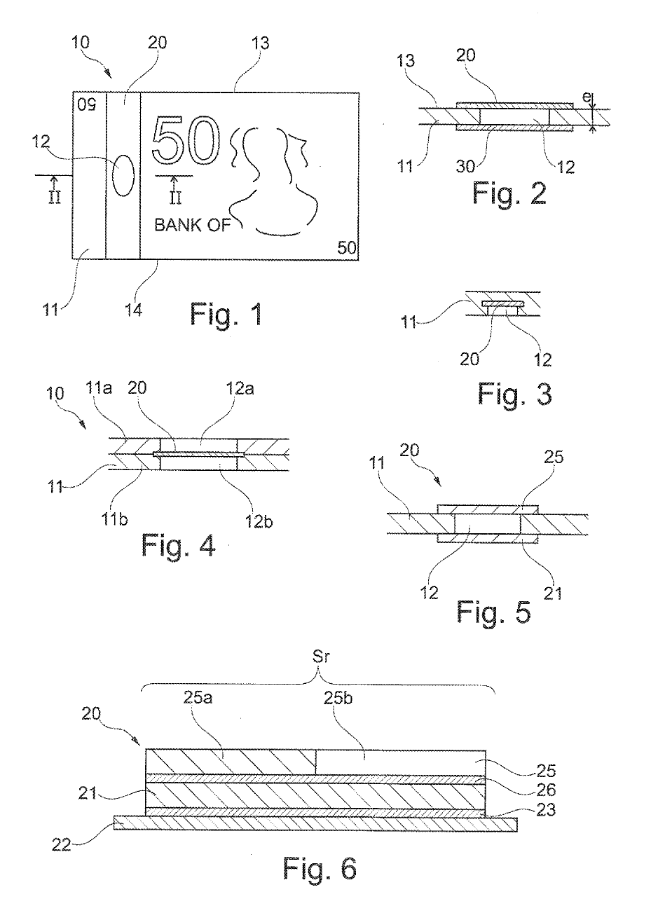

FIG. 1 schematically represents an example of an item secured according to the invention,

FIG. 2 is a section along II-II in FIG. 1,

FIGS. 3 to 22 represent other examples of secured items or security elements according to the invention.

In the schematic figures, the actual relative proportions of the various layers have not necessarily been respected, for the sake of clarity in the drawing. Some layers may have been represented monolithically for the sake of simplification, whereas they may consist of multiple sub-layers in reality, as is the case, for example, of the holographic layer which may consist of a multilayer complex. In addition, some layers may be assembled by the use of adhesive layers arranged therebetween, which are not always represented in the figures. Finally, in the presence of juxtaposed opaque and non-opaque areas, this presence is only schematically represented with just two areas arranged side by side, it being understood that in reality these various areas will most often be more than two, with arrangements that may be complex, for defining a text or a microtext or a raster image, for example. The secured item 10 represented in FIG. 1, e.g. a banknote, comprises a substrate 11, e.g. fibrous, such as paper, provided with a window 12, produced, for example, by cutting the substrate 11 or one ply thereof in the case of a multiply structure, this window 12 being covered on one side by a security element 20 according to the invention, as illustrated in FIG. 2, and on the other side by a sealing film 30, which may be arranged in register with respect to the element 20. For example, the sealing film 30 may be a semi-reflective film. Advantageously, the semi-reflective layer is used to enhance the volume hologram owing to the reflective appearance of the layer while maintaining visibility in transmitted light. In addition, this semi-reflective layer may serve to mask the security element when the latter is introduced into windows (‘windows thread’), which is particularly useful when a color is superimposed on the security element. Finally, in the case of a security element arranged in a through-window, the semi-reflective layer masks the security element in reflection on the face on which the layer is arranged.

The invention is not limited to one type of secured item in particular, and the latter may also be an identity document such as an identity card, for example, or an access card. The substrate 11 may thus be non-fibrous.

The window 12 may have an outline of any shape, e.g. circular, elliptical or polygonal, in particular a regular or irregular polygon.

The window 12 may be the only one in the document, or the latter may comprise several of them. In this case, the windows may be arranged on the same face of the document or on opposite faces. Preferably, the windows are arranged on opposite faces of the document, so that at least one window on one face of the document is at least partially superimposed on one window on the other face to form a through-window together.

The security element 20, just like the sealing film 30, may be in the form of strips extending from one side 13 of the document to the opposite side 14.

The width of the sealing film 30 and that of the security element 20 are preferably each greater than the width of the window 12, so that the security element 20 extends beyond the window 12, as does the sealing film 30, on all sides.

The substrate 11 has a thickness e between, for example, 10 and 1000 μm, better between 50 and 700 μm.

The substrate 11 may comprise natural and/or synthetic fibers. The substrate may also be non-fibrous or formed of a multilayer structure comprising at least one fibrous layer and one layer of thermoplastic material.

The element 20 may be attached onto the substrate 11 by hot or cold lamination and/or bonding.

The same applies to the protective film 30.

In FIG. 3, the security element 20 is in the form of a thread incorporated in window(s) in the substrate 11.

The thread is, for example, incorporated during the formation of the fibrous substrate 11 on a cylinder machine, for example, the windows being formed, for example, by modifying the accumulation of fibers on the forming fabric. As a variant, the substrate 11 is two-ply and the thread is introduced between the plies, of which at least one has windows, the plies being, for example, assembled in the wet phase.

In the example of FIG. 4, the document 10 comprises a substrate 11 formed of two fibrous plies 11a and 11b assembled together. The security element 20 is arranged between the plies 11a and 11b.

The ply 11a comprises a window 12a and the ply 11b a window 12b, which is at least partially superimposed on the window 12a, so that the element 20 may be observed through the windows 12a and 12b in transmitted light.

In the case where the security element 20 is a security thread, its width may be relatively small, preferably less than or equal to 10 mm.

The security element 20 may also be a patch inserted between two plies of paper or bonded onto the surface of the substrate. The patch does not extend over the whole width of the substrate 11.

The security element 20 may be composed of multiple constituent elements arranged on each side of the substrate 11 of the document 10.

Consequently, in the example of FIG. 5, the security element 20 comprises a variable opacity structure 25 arranged on one side of the substrate 11 and a holographic layer 21 arranged on the opposite side. At least one window 12 allows observation through the superimposition of the variable opacity structure 25 and the volume hologram generated by the holographic layer 21. This window 12 is optionally filled with a transparent solid material.

In general, the security element 20 may be added onto a non-fibrous substrate, such as a film made of flexible or rigid thermoplastic material. The security element 20 may also be incorporated in a multilayer structure comprising at least one fibrous layer, made of paper, and a layer made of thermoplastic material.

The security element 20 may also be incorporated between two sheets of transparent thermoplastic material.

The item 10 may comprise various first level, second or third level ancillary security elements. Among the additional security elements, some are detectable to the eye, in daylight or in artificial light, without the use of a special device. These security elements comprise, for example, colored fibers or planchettes, printed or totally or partially metalized threads. These security elements are termed first level. Other types of additional security elements are detectable only by using a relatively simple device, such as a lamp emitting ultraviolet (UV) or infrared (IR) radiation. These security elements comprise, for example, fibers, planchettes, strips, threads or particles. These security elements may or may not be visible to the naked eye, being, for example, luminescent under the light of a Woods lamp emitting at a wavelength of 365 nm. These security elements are termed second level.

Other types of additional security elements require a more sophisticated detection device for their detection. These security elements are, for example, capable of generating a specific signal when they are subjected, simultaneously or not simultaneously, to one or more sources of external excitation. The automatic detection of the signal makes it possible to authenticate the document, where appropriate. These security elements comprise, for example, tracers in the form of active materials, particles or fibers, capable of generating a specific signal when these tracers are subjected to an optronic, electrical, magnetic or electromagnetic excitation. These security elements are termed third level.

In FIGS. 2, 3 and 4, the security element 20 has been represented in simplified form. In particular, the holographic layer 21 that it comprises may consist of a multilayer complex.

A description will now be given referring to FIGS. 6 through 22 of different examples of security elements 20 according to the invention.

In all these figures, the reference 21 designates a holographic layer in which the volume hologram has been recorded. This hologram may have been recorded in reflection or transmission. This layer may reproduce as a hologram only a solid color, i.e. the whole of the layer appears in the same color, when observed, for example, in reflection in visible light in the case of a hologram recorded in reflection, e.g. the color green, red, yellow, orange, purple or blue.

When in general the holographic layer 21 does not reproduce a solid color, the distribution of areas of different colors may define an alphanumeric text, a logo, or a more complex image, such as a character, animal, landscape or building.

The number of colors reproduced by the holographic layer 21, under observation in illuminating white light D₆₅, may be equal to 1 or as a variant be greater than 1.

During the reproduction by the holographic layer 21 of at least two colors, one of the colors may define a text or a raster of dots and the other color a plain background around this text or these dots.

The security element 20 may also comprise, as illustrated in FIG. 6 in particular, a backing layer 22 which is, for example, a film made of transparent thermoplastic material, e.g. PET. Alternatively, the backing layer 22 may consist of a fibrous material such as paper. The thickness of the holographic layer 21, particularly when it consists of a photosensitive resin complex bonded onto a carrier film, is, for example, between 1 and 20 μm.

The thickness of the backing layer 22 is, for example, between 3 and 100 μm.

The backing layer 22 may optionally bear one or more other layers, on the side located opposite the holographic layer 21.

In the example of FIG. 6, the holographic layer 21 is attached via an adhesive layer 23 to the backing layer 22. The same applies in the example of FIG. 8.

The thickness of the adhesive layer 23 is, for example, between 1 and 10 μm, preferably between 1 and 5 μm.

The adhesive used is, for example, a polyurethane-based or urethane-acrylate copolymer-based adhesive such as those in the NOLAX range.

In accordance with the first aspect of the invention, the security element 20 also comprises a variable opacity structure 25, e.g. in the form of single layer, which is at least partially superimposed on the holographic layer 21, in at least one overlap region, Sᵣ in extent.

The layers 21 and 25 may be of similar extent to said overlap region, which is preferred, as illustrated in FIGS. 6 and 8 in particular.

However, as a variant, the overlap region is formed by the superimposition of layers 21 and 25 on only one part of their extent, the holographic layer 21 being, for example, less wide than the layer 25 or vice versa. Preferably, with holographic layer 21 occupying an extent of Sₕ, then Sᵣ/Sₕ≧0.5, better Sᵣ/Sₕ≧0.75.

When the security element 20 in place on the document 10 is observed, the entire overlap region may be visible, or as a variant only one part of the latter, the overlap region being, for example, partially hidden by the substrate 11.

The backing layer 22 may cover all or part of the corresponding face of the substrate 11.

In FIGS. 1 and 2, the backing layer 22 only occupies one part of the face 13 of the substrate 11; as a variant, the backing layer 22 forms a protective film for the whole of the face 13. The holographic layer 21 only extends, for example, in the region of the window 12, or extends both over the latter and over the substrate 11. This makes it possible to create an additional effect, by allowing a contrast to be observed during the reproduction of the hologram, between what is visible through the window and what is outside the window. The holographic layer 21 may cover between 5 and 100% of the total extent of the face 13 of the backing 22.

In general, the holographic layer 21 may extend continuously over the document 10, i.e. there are not two unconnected regions formed by the holographic layer 21. As a variant, the holographic layer 21 extends discontinuously over the document 10. For example, portions of the holographic layer 21 are repeated at regular intervals over the backing layer, these portions being unconnected. These portions may reproduce the same color or distinct colors. These portions may reproduce a hologram for the same angle of observation or for different angles.

In general, the variable opacity structure 25 may have a variable opacity in its plane.

For example, the variable opacity structure is formed by a layer 25 which has one or more opaque regions 25a and one or more non-opaque regions 25b, or the regions 25a corresponding, for example, to the presence of metalization and/or printing and/or to the presence of an at least partially opaque, particularly fibrous, apertured layer, and the region or regions 25b to the presence of demetalization and/or to an absence of printing and/or to cutouts in said apertured layer or to translucent areas. The non-opaque regions may thus be formed otherwise than by a cutout through an opaque fibrous substrate.

Patterns may be formed by the opaque and/or non-opaque regions. These patterns are, for example, alphanumeric characters and/or logos and/or any other figurative mark. It may be a text providing information on the name of the bank, the country and/or the value of the bill.

In the case where the non-opaque regions 25b are formed by cutouts in at an least partially opaque, particularly fibrous layer, these cutouts may consist of microperforations, each occupying, for example, between 0.5 and 10⁻⁹ cm².

In the example of FIG. 9, the variable opacity structure 25 is in the form of an apertured layer comprising microperforations 25b. The apertured layer is, for example, a paper ply and the microperforations 25b are, for example, made using a laser through the paper ply.

In general, the information that appears on observing in transmitted light the pattern or patterns defined by the variable opacity structure 25 may be found on the secured document elsewhere, particularly when this information concerns the value of the bill in the case of a banknote.

The patterns may be observable to the naked eye or require the use of a magnifying device to be capable of being observed.

Observation is done preferably in white light, the hologram being preferably reproduced under this lighting. As a variant, observation is done under UV or IR light, particularly when the holographic layer 21 is provided for this purpose.

The largest dimension of a pattern, particularly of a character, formed by demetalization, within the variable opacity structure 25, is, for example, less than or equal to 2 mm, and that of a pattern formed by metalization or printing may also be less than or equal to 2 mm. The pattern produced by metalization/demetalization may produced in accordance with the teaching of application WO 2006/066927, in the form of dots reproducing an image in transmitted light.

In general, in the case of a variable opacity structure 25 produced from a metalized layer, this layer may comprise as constituent sub-layers a backing film, e.g.

made of PET, and a deposit of one or more metals on this film, on one side or on two opposite sides of this film. The thickness of metal depends on the opacity sought in the opaque areas. Aluminum, copper, gold, iron, silver, chromium, nickel, zinc, cadmium, bismuth, and their alloys and oxides may be cited as metals that can be used to produce the variable opacity structure 25 by metalization/demetalization.

The variable opacity structure 25 may comprise raster dots defining an image of an object, a character, a building or a landscape, for example.

In the case where the variable opacity structure 25 defines a raster image, it may be advantageous that the hologram reproduces either a solid color forming a colored background facilitating the perception of the image, e.g. a green background that seems to backlight the image, the raster image thus being visible in reflection.

The variable opacity structure 25 may be rigidly attached to the holographic layer 21 via an at least partially translucent adhesive layer 26, as illustrated in FIG. 6 in particular.

The adhesive layer 26 may be replaced by a protective layer such as a varnish, which is deposited on the holographic layer 21, and which serves as a backing for the opaque areas 25a, which are then formed, for example, by printing. The nature of the adhesive layers 23 and 26 may be the same.

In the example of FIG. 10, the variable opacity layer 25 is situated between the holographic layer 21 and the backing layer 22.

For example, the backing layer 22 receives printing or metalization to form a variable opacity structure 25 and the holographic layer 21, preferably as a self-supporting multilayer complex, is deposited on this layer 25. The holographic layer 21 may be covered with a transparent protective film 27, optionally bearing additional security measures.

The protective film 27 may consist of a transparent film of a thermoplastic material such as polyethylene, polypropylene and other polyolefins, PTFE, PVDF, EVA, PVA (polyvinyl alcohol), PMMA, PS (polyethersulfone), PEK (polyetherketone), PA, tetrafluoroethylene-perfluoroalkyl vinyl ether copolymer), PET and polyamide. The thickness of the film preferably ranges from 2 to 200 μm, better from 10 to 50 μm. The example in FIG. 8 depicts the structure in FIG. 6, except for the use of a layer of colored adhesive 23 for attaching the holographic layer 21 to the backing layer 22. This makes it possible to modify the appearance of the security element 20, particularly when the latter is observed in transmission or in reflection. The color of the adhesive layer 23 may be chosen according to the that of the hologram reproduced by the holographic layer 21, so as to generate a third color by additive synthesis from the other two colors, e.g.

to generate yellow from green (hologram) and red (colored adhesive). In one variant, the adhesive layer is colorless but an additional colored film is inserted between the backing layer 22 and the holographic layer 21.

As a further variant, colored printing is deposited on the backing layer 22 or the holographic layer 21.

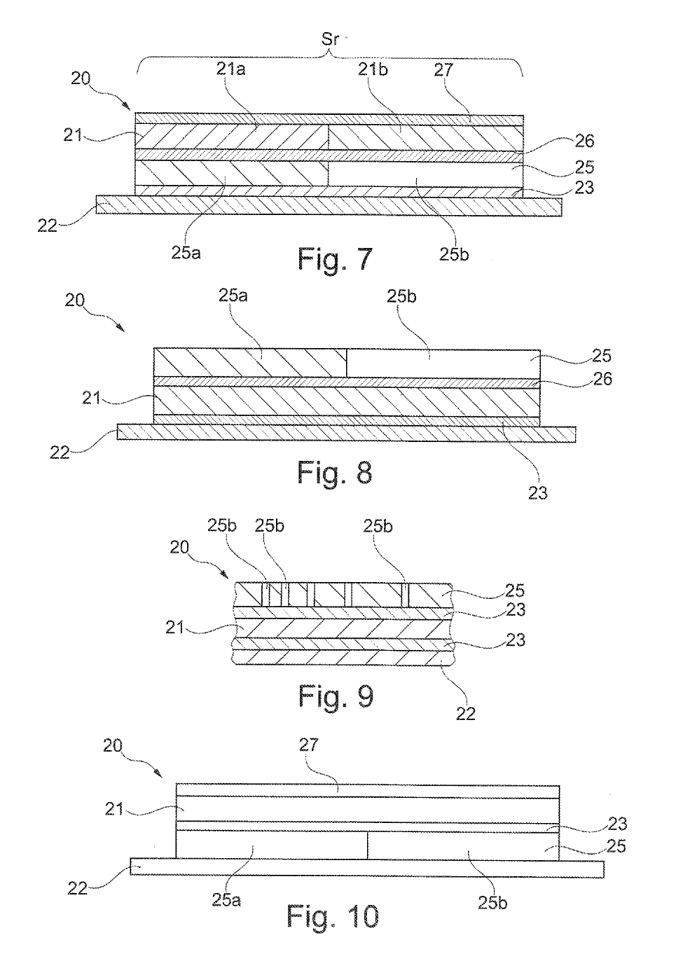

In the example of FIG. 7, the holographic layer has areas 21a and 21b, which may appear in different colors owing to the fact of the superimposition of these areas 21a and 21b with the colored layer 23 and the presence of the variable opacity layer. These areas 21a and 21b may appear to the observer for the same angle of observation or for different angles.

An area 21a or 21b appearing in a given color of the holographic layer 21 may be superimposed exactly with an area of given opacity of the variable opacity structure 25; in the example of FIG. 7, this is the case of the area 21a which is superimposed exactly on the opaque area 25a and the case of the area 21b which is superimposed exactly on the non-opaque area 25b, for presenting a different color by superimposition with the colored layer 23.

A colored layer may be interposed between the variable opacity layer 25 and the backing layer 22, this colored layer being, for example, as illustrated in FIG. 7, a colored adhesive layer 23. Another, non-colored, adhesive layer 26 may ensure the attachment of the holographic layer 21 on the variable opacity structure 25.

In variants, the backing layer 22 is located between the holographic layer 21 and the variable opacity structure 25.

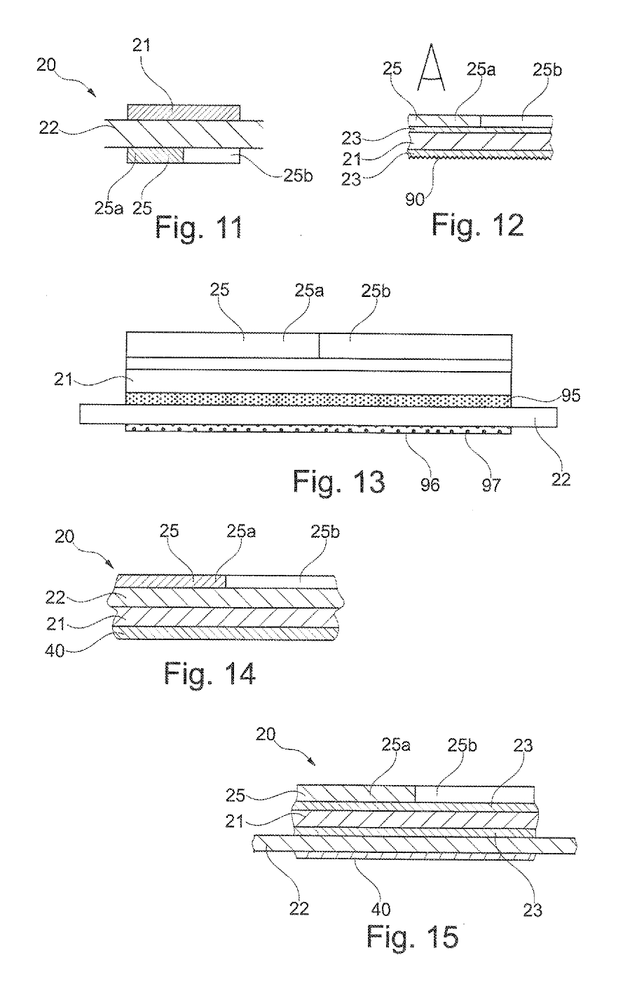

For example, as illustrated in FIG. 11, the backing layer 22 on one face bears a variable opacity structure 25 containing a metalization with demetalized non-opaque areas 25b, and the holographic layer 21 is applied on the other face. This embodiment is particularly suitable when the security element 20 is incorporated in a document window. In the example of FIG. 12, the security element 20 comprises a diffusing structure 90, arranged under the holographic layer 21 with respect to the observer. The diffusing structure 90 is preferably micro-embossed and consists, for example, of a layer of an adhesive 23 which is micro-embossed, and makes it possible to diffuse light and make the visibility of the volume hologram less dependent on the angle of observation or the recording angle of the pattern. This is advantageous. In addition, this reduces the risk of the angle of visibility of the hologram coinciding with the angle corresponding to the specular reflection of light (sunlight or artificial point source light) on the variable opacity structure 25, particularly when it is reflective, e.g. metalized, which facilitates observation of the hologram and the variable opacity structure 25 in reflection. Preferably, as illustrated, the variable opacity structure 25 is located opposite the diffusing structure 90. In this FIG. 12, the backing layer 22, which may be absent or located, for example, between the holographic layer 21 and the diffusing structure 90, has not been represented.

In other variants, the backing layer 22 bears on the opposite side to the holographic 21 and variable opacity 25 layers one or more additional security measures, e.g. printing with a luminescent ink, a lenticular network, another volume hologram or a surface hologram, a raster, a deposit of semi-transparent metal, etc. In particular, the security element 20 may have a combination of luminescent agents on the front and the back that change the color of the volume hologram.

There is, for example, as illustrated in FIG. 13, a first luminescent agent 95 contained in an adhesive layer 23 ensuring the attachment of the holographic layer 21 on the backing layer 22 and a second luminescent agent 96 contained in a layer 97 superimposed on the layer 23 containing the luminescent agent 95. The luminescent agents 95 and 96 are, for example, pigments or dyes, preferably dyes. Layer 97 is, for example, a varnish. The luminescence colors of the luminescent agents 95 and 96 are preferably different. Preferably, the luminescent agents are fluorescent.

There may be in this example in particular a holographic layer which reproduces a color under observation in the visible range and another color under UV or IR observation. Preferably, in this case excitation is on the side opposite to that of the observer for viewing by transmission.

In the example of FIG. 14, a semi-reflective film 40 covers the holographic layer 21, on one side of the backing layer 22. On the other side, the backing layer 22 bears a variable opacity structure 25.

In the example of FIG. 15, a semi-reflective film 40 is present in the security element 20, superimposed on the variable opacity structure 25 and the holographic layer 21. The latter may reproduce a hologram recorded in reflection or transmission. The semi-reflective film 40 is located on the side of the holographic layer 21 opposite the variable opacity structure 25.

The film 40, owing to its semi-reflective nature, and therefore not completely opaque, makes it possible to observe the pattern or patterns defined by the variable opacity structure 25, when the element 20 is observed in transmitted light.

In the example of FIG. 15, the semi-reflective film 40 is present on the face of the backing layer 22 opposite the hologram 21. This may be, for example, a thin metal deposit.

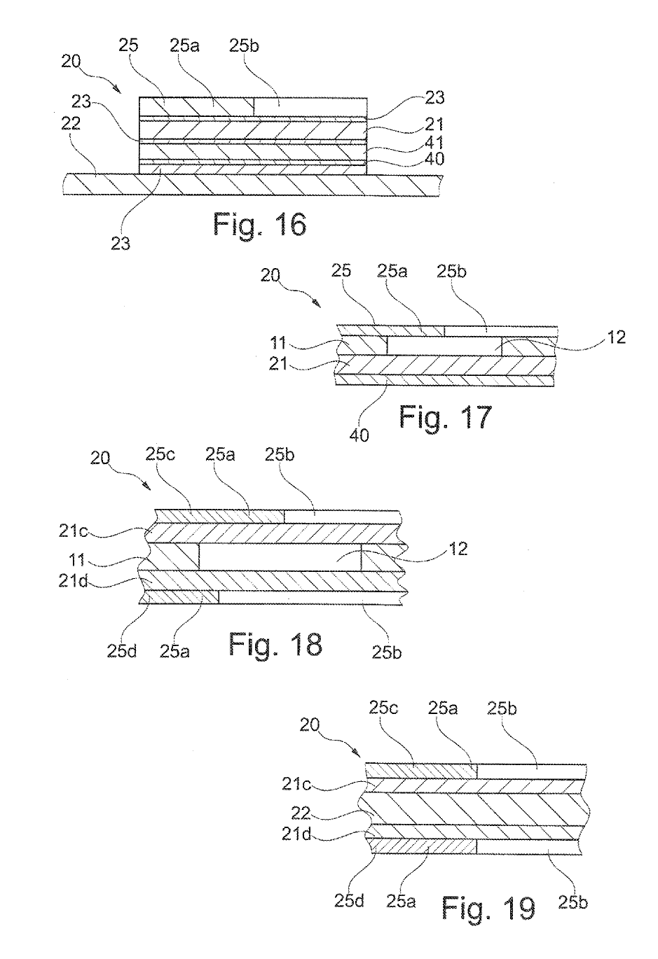

In the variant illustrated in FIG. 16, the semi-reflective film 40 is carried by a transparent film 41 which is located on the same side of the backing layer 22 as the hologram 21 and the variable opacity structure 25.

In the example of FIG. 17, the security element 20 comprises a variable opacity structure 25 arranged on the substrate 11, on the side opposite the holographic layer 21 and the semi-reflective layer 40.

In FIG. 18, a security element 20 has been represented which is observed in transmitted light thanks to a window 12 of a substrate 11 of the document 10.

The security element 20 comprises a holographic layer 21c, covered by a variable opacity structure 25c, preferably formed by metalization/demetalization.

The hologram 21c and the variable opacity structure 25c are located on one side of the substrate 11.

The element 20 comprises, on the other side of the substrate 11, another holographic layer 21d, superimposed on a variable opacity structure 25d, preferably formed by metalization/demetalization.

The opaque areas 25a of the variable opacity structure 25c may be superimposed exactly on the opaque areas 25a of the variable opacity structure 25d and the same may apply to the non-opaque areas 25b of the variable opacity structures 25c and 25d. As a variant, the opaque areas 25a are not superimposed exactly, just like the non-opaque areas 25b. For example, the opaque 25a and non-opaque 25b areas of the variable opacity structure 25c may define micro-patterns inside larger dimensioned patterns defined by the areas 25a and 25b of the other variable opacity structure 25d, e.g. a microtext inside larger dimensioned characters. Conversely, the micro-patterns are defined by the areas 25a and 25b of the variable opacity structure 25d.

The hologram reproduced by the holographic layer 21c may be a hologram recorded in transmission and the one reproduced by the holographic layer 21d a hologram recorded in reflection.

In the example of FIG. 19, the holographic layers 21c and 21d are carried by a transparent backing layer 22 located on each side of the latter. The holographic layers 21c and 21d are covered by respective variable opacity structures 25c and 25d. The features described with reference to the example of FIG. 18 are valid for the example of FIG. 19.

The holographic layer 21 may be recorded so as to reproduce a hologram that presents at least two areas 21a and 21b which are of different colors, e.g. when the security element 20 is observed in reflection under white light lighting.

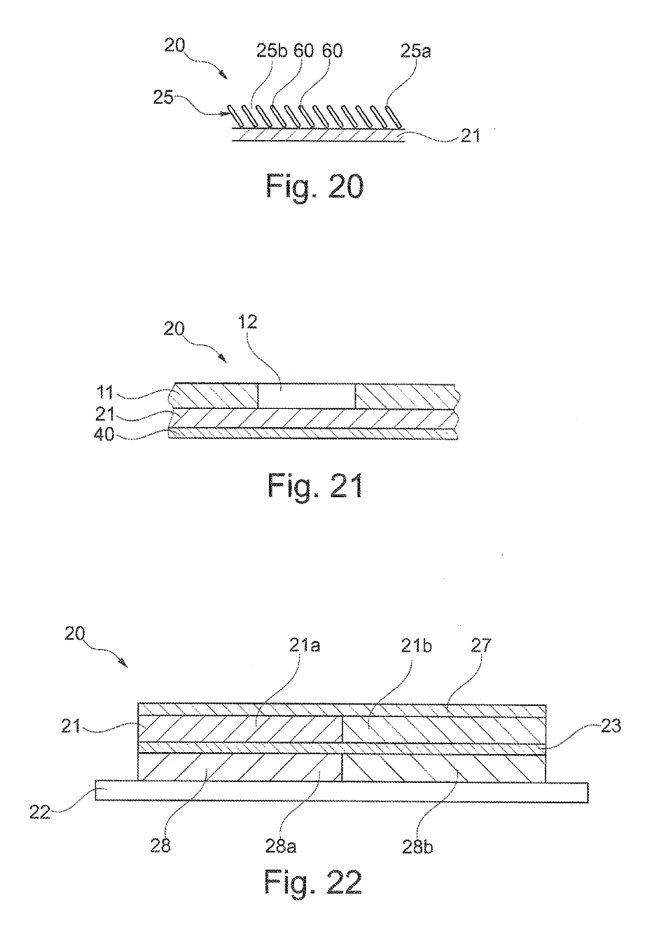

A security element 20 has been represented in FIG. 20 in which the variable opacity layer is formed by oriented platelet pigments, covering the volume hologram 21.

The pigments 60 are oriented substantially parallel to one another and are not parallel to the plane of the volume hologram 21, so that for a certain direction of observation, substantially parallel to the direction of orientation of the pigments 60, it is possible to see the volume hologram through the variable opacity layer 25. The pigments 60 may be such as those described in the publication WO 2012/176169 A1.

In FIG. 21, a security element 20 has been represented according to another aspect of the invention, which comprises a semi-reflective film 40 which is superimposed on the holographic layer 21. A window 12, made in the substrate 11, makes it possible to observe the security element 20 in transmitted light. According to this other aspect of the invention, the variable opacity structure 25 of the preceding examples is absent.

The security element 20 may comprise a variable chromaticity layer, with, for example, two areas of different colors or one or more colored areas and one or more non-colored areas. The colored area or areas are, for example, colored by printing.

The colored area or areas of this variable chromaticity layer may be arranged in register with respect to the arrangement of the different areas 21a and 21b of the holographic layer 21.

For example, as illustrated in FIG. 22, one area 21a of a given color of the holographic layer is superimposed exactly with an area 28a of a given color of the variable chromaticity layer 28, just like the areas 21b and 28b.

This figure also illustrates the fact that according to another aspect of the invention, the variable opacity structure 25 of the other examples may be absent.

The invention is not limited to the examples illustrated.

Thus, the diffusing structure 90 of the example in FIG. 12 may be added to the other examples illustrated, in particular opposite the variable opacity structure 25. The same applies to the semi-reflective layer 40.

More generally, the features of the examples illustrated may be combined within variants not illustrated.

The expression ‘comprising a’ is synonymous with ‘comprising at least one’, unless otherwise specified.

1. A security element to be incorporated in an item, the security element comprising:
a holographic layer for generating a volume hologram,
a non-holographic variable opacity structure, generated by the presence of:
a) one or more cutouts and/or at least partially translucent areas as well as one or more at least partially opaque areas, and/or
b) oriented platelet pigments,
the variable opacity structure being at least partially superimposed on the hologram in a region of the security element observable in transmitted light.

2. The element as claimed in claim 1, the hologram being recorded with a solid color or the hologram being recorded with at least two colors.

3. The element as claimed in claim 1, the variable opacity structure comprising metalization.

4. The element as claimed in claim 1, the variable opacity structure comprising printing.

5. The element as claimed in claim 1, the variable opacity structure comprising cutouts, made in an at least partially opaque layer.

6. The element as claimed in claim 1, the hologram being at least partially visible on one side or the other of the element, directly or indirectly through one or more non-opaque layers.

7. The element as claimed in claim 1, comprising a non-opaque colored layer at least partially superimposed on the hologram and/or on the variable opacity structure.

8. The element as claimed in claim 7, the colored layer being colored by printing and/or colored in the mass.

9. The element as claimed in claim 1, comprising a second holographic layer for generating a second volume hologram, at least partially superimposed on the first hologram, the second hologram being superimposed on at least one non-opaque area of the variable opacity structure.

10. The element as claimed in claim 1, comprising different first and second holograms, the first and second hologram being respectively superimposed preferably on different patterns defined by the variable opacity structure or being intended to appear in different windows of a substrate.

11. The security element as claimed in claim 1, the variable opacity structure comprising oriented platelet pigments offering an opacity which depends on the angle of observation.

12. The element as claimed in claim 1, comprising a layer of an adhesive.

13. The element as claimed in claim 1, comprising a backing layer.

14. The element as claimed in claim 1, the hologram comprising two juxtaposed areas of different colors, and the element comprising two juxtaposed colored areas, of different colors, superimposed on the colored areas of the hologram.

15. The element as claimed in claim 1, comprising a semi-reflective film at least partially superimposed on the holographic layer and the variable opacity structure.

16. The element as claimed in claim 1, the hologram having been recorded in reflection.

17. The element as claimed in claim 1, the hologram having been recorded in transmission.

18. A secured item comprising a security element as defined in claim 1, observable in transmitted light and in reflection at least in said region of superimposition of the volume hologram and the variable opacity structure.

19. The item as claimed in claim 18, the security element being superimposed on a document window.

20. The item as claimed in claim 19, the window being a through-window and the security element being arranged on one side of the window, with a sealing film being arranged on the other side of the window.

21. The item as claimed in claim 20, the sealing film being colored.

22. A method of authenticating an item as defined in claim 18, comprising the observation of the security element, in reflection and/or in transmission.

23. The method of authentication as claimed in claim 22, in which the inclination of the angle of observation is varied with respect to the security element and information is drawn concerning authenticity in the event of the successive appearance of patterns.

24. The method as claimed in claim 22, observation being performed with the hologram located behind the variable opacity structure with respect to the observer.

25. The element as claimed in claim 9, one of the two holograms being a hologram recorded in transmission and the other a hologram recorded in reflection.

26. The element as claimed in claim 25, the two holograms being located on each side of a substrate comprising a window through which an observation may be made in transmitted light.
